(19) United States
(12) Patent Application Publication
(10) Pub. No.: US 2006/0008008 A1
(43) Pub. Date: Jan. 12, 2006

(54) Method of multi-resolution based motion estimation and recording medium storing program to implement the method

(75) Inventor: Byung-cheol Song, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/175,343

(22) Filed: Jul. 7, 2005

(30) Foreign Application Priority Data
Jul. 8, 2004 (KR) 10-2004-0053037

(51) Int. Cl. H04B 1/66; H04N 11/02; H04N 11/04; H04N 7/12

(52) U.S. Cl. 375/240.16; 375/240.12; 375/240.24

(57) ABSTRACT

A method of multi-resolution based motion estimation is provided. The method includes calculating an initial motion vector in a predetermined block of a current frame at a low resolution; determining a search area at a middle resolution based on the initial motion vector; performing motion estimation in the search area for each of a plurality of modes, each mode being obtained by dividing a macro block into a predetermined sub macro blocks; and selecting at least one mode among the plurality of modes which have each been subjected to the motion estimation at the middle resolution, and performing motion estimation for a high resolution based on motion vectors for the selected modes, wherein the plurality of modes have different sized sub macro blocks.

### CROSS-REFERENCE TO RELATED APPLICATIONS

This application claims the benefit of Korean Patent Application No. 10-2004-0053037, filed on Jul. 8, 2004, in the Korean Intellectual Property Office, the disclosure of which is incorporated herein in its entirety by reference.

### BACKGROUND OF THE INVENTION

1. Field of the Invention

The present invention relates to video encoding, and more particularly, to a method of multi-resolution based motion estimation and recording medium storing a program to implement a method of multi-resolution based motion based estimation.

2. Description of the Related Art

In a video encoder, a motion estimation unit is often considered to have the most computational complexity. In order to reduce the computational complexity of the motion estimation unit, a fast motion estimation method is used. Compared to a full search block matching algorithm, the fast motion estimation method performs faster calculation without lowering performance. The full search block matching algorithm divides a current frame and a reference frame into equal-sized blocks, and then estimates a two-dimensional motion vector of each block by comparing each block of the current frame to all the blocks within a search area of the reference frame to find the best match based on a given matching criterion. A Sum of Absolute Differences (SAD) is one of the matching criteria used to determine the best match. Of the fast motion estimation methods, a hierarchical multi-resolution search scheme has been preferably employed.

FIG. 1 is a diagram illustrating a hierarchical frame structure for a hierarchical motion vector search scheme.

Referring to FIG. 1, a macro block in layer 0 consists of 16×16 pixels. Layer 1 is obtained by taking mean pixels from neighboring 2×2 pixels in layer 0, in which a macro block consists of 8×8 pixels. Layer 2 is obtained by taking mean pixels from neighboring 2×2 pixels in Layer 1, in which a macro block consists of 4×4 pixels. A 3 layered-frame structure is illustrated herein, however it should be appreciated that other alternative frame structures, such as 2 layered, or more than 3 layered, can also be used.

FIG. 2 is a diagram for explaining a hierarchical motion vector search method.

Referring to FIG. 2, there are 3 searching processes in a low resolution layer (layer 2), a middle resolution layer (layer 1), and a high resolution layer (layer 0).

Generally, hierarchical motion estimation is performed by the following operations:
(i) performing a full search in the lowest resolution layer, and determining search points having a minimum SAD resulting from the full search to be initial search points for the middle resolution layer in operation 220;
(ii) performing a local search within small areas in the middle resolution layer, centered on the initial search points determined in operation (i), and determining search points having a minimum SAD resulting from the local search to be initial search points for the high resolution layer in operation 240; and
(iii) estimating final motion vectors from local search within small areas in the high resolution layer, centered on initial search points determined in operation (ii).

However, such a hierarchical motion search scheme requires excessive computations when the scheme is applied in a multi reference frame method or a block divisional method.

Accordingly, there is a need to provide a method of estimating motion vectors based on block division and multi-resolution, and there is a need for recording media storing a program to implement the method.

### SUMMARY OF THE INVENTION

Additional aspects, features, and/or advantages of the invention will be set forth in part in the description which follows and, in part, will be apparent from the description, or may be learned by practice of the invention.

The present invention provides a method of multi-resolution based motion estimation, and a recording medium storing a program to implement the method.

According to an aspect of the present invention, there is provided a method of multi-resolution based motion estimation, the method including: calculating an initial motion vector in a predetermined block of a current frame at a low resolution; determining a search area at a middle resolution based on the initial motion vector; performing motion estimation in the search area for each of a plurality of modes, each mode being obtained by dividing a macro block into a predetermined sub macro blocks; and selecting at least one mode among the plurality of modes which have each been subjected to the motion estimation at the middle resolution, and performing motion estimation for a high resolution based on motion vectors for the selected modes, wherein the plurality of modes have different sized sub macro blocks.

According to an aspect of the present invention, the selecting of at least one mode is performed on the basis of results from motion estimation for each mode.

According to an aspect of the present invention, if one of the selected modes is composed of minimally sized sub macro blocks, performing motion estimation for the high resolution includes performing motion estimation for each of a plurality of modes, each mode being obtained by dividing a minimum-size sub macro block into a predetermined number of sub blocks.

According to an aspect of the present invention, the plurality of modes are obtained by dividing the macro block into a 16×16 sized sub macro block, two 16×8 sized sub macro blocks, two 8×16 sized sub macro blocks, and four 8×8 sized sub macro blocks, and for each mode, motion estimation is performed in every sub macro block, and thereby the number of motion vectors for each mode is equal to the number of sub macro blocks in the corresponding mode.

According to an aspect of the present invention, selecting at least one mode is performed by selecting one or more modes having the lowest costs in motion estimation, the costs including one or more factors from among sum of absolute differences (SAD), bits of a motion vector, and bits of mode information.

According to an aspect of the present invention, the initial motion vector is calculated with reference to at least one frame neighboring the current frame.

According to an aspect of the present invention, the method further includes: calculating an additional motion vector using motion vectors of neighboring blocks of a predetermined block, wherein determining the search area for the middle resolution includes determining a search area based on the additional motion vectors.

According to an aspect of the present invention, the additional motion vector has a median value of the motion vectors of the neighboring blocks.

According to an aspect of the present invention, if one of the selected modes is a mode for motion estimation in an 8×8 sized sub macro block, the motion estimation for the high resolution includes performing motion estimation for each of a plurality of modes, each mode being obtained by dividing the 8×8 sized sub macro block into a predetermined number of sub blocks.

According to an aspect of the present invention, the motion estimation method is applicable to an H.264 encoder.

According to an aspect of the present invention, performing motion estimation for each mode at the middle resolution level is done by independently calculating SAD for every sub macro block of the corresponding mode in the search area.

According to an aspect of the present invention, performing motion estimation for each mode at the high resolution layer is done by independently calculating SAD for every sub block of the corresponding mode in the search area.

According to another aspect of the present invention, there is provided a recording medium storing a program to implement a method of multi-resolution based motion estimation, the method including: calculating an initial motion vector in a predetermined block of a current frame at a low resolution; determining a search area at a middle resolution based on the initial motion vector; performing motion estimation in the search area for each of a plurality of modes, each mode being obtained by dividing a macro block into a predetermined number of sub macro blocks; and selecting at least one mode among the plurality of modes which have each been subjected to the motion estimation at the middle level, and performing motion estimation for a high resolution based on motion vectors for the selected modes, wherein the plurality of modes have different sized sub macro blocks.

According to an aspect of the present invention, there is provided a method of multi-resolution based motion estimation, the method including performing a motion estimation for a reference frame of a current macro block at a low resolution to provide an initial motion vector; determining a search area at a middle resolution based on the initial motion vector; performing motion estimation in the search area for each of a plurality of modes, each mode being obtained by dividing a macro block into sub macro blocks, wherein one of the sub macro blocks is the macro block; selecting at least one mode among the plurality of modes subjected to the motion estimation at the middle resolution; and performing motion estimation for a high resolution based on motion vectors for the selected modes.

According to another aspect of the present invention, there is provided at least one computer readable medium storing instructions that control at least one processor which executes a method of multi-resolution based motion estimation to perform the method including performing a motion estimation for a reference frame of a current macro block at a low resolution to provide an initial motion vector; determining a search area at a middle resolution based on the initial motion vector; performing motion estimation in the search area for each of a plurality of modes, each mode being obtained by dividing a macro block into sub macro blocks, wherein one of the sub macro blocks is the macro block; selecting at least one mode among the plurality of modes subjected to the motion estimation at the middle resolution; and performing motion estimation for a high resolution based on motion vectors for the selected modes.

### BRIEF DESCRIPTION OF THE DRAWINGS

These and/or other aspects, features, and advantages of the invention will become apparent and more readily appreciated from the following description of the exemplary embodiments, taken in conjunction with the accompanying drawings of which:

FIG. 1 shows an exemplary hierarchical frame structure in a method of hierarchically estimating motion vectors;

FIG. 2 is a diagram illustrating a method in a related art of hierarchically estimating motion vectors;

FIG. 3 is a block diagram illustrating a video encoding system in which an exemplary embodiment of the present invention is applied;

FIG. 4 is a block diagram illustrating another video encoding system to which an exemplary embodiment of the present invention is applied;

FIG. 5 is a diagram illustrating a method of searching for motion vectors at low resolution according to an exemplary embodiment of the present invention;

FIG. 6 is a diagram illustrating a method of searching for motion vectors at middle resolution according to an exemplary embodiment of the present invention;

FIG. 7 is a diagram to show a method of searching motion vector at a high resolution according to an exemplary embodiment of the present invention;

FIG. 8 shows an example of motion vectors of neighboring macro blocks to be used as initial motion vectors, according to an exemplary embodiment of the present invention;

FIG. 9 shows various division modes of a macro block;

FIG. 10 shows various division modes of a sub-macro block;

FIG. 11 is a flowchart illustrating an exemplary embodiment of a method of multi-resolution based motion estimation, according to an exemplary embodiment of the present invention; and

FIG. 12 is a flowchart illustrating another exemplary embodiment of a method of multi-resolution based motion estimation, according to an exemplary embodiment of the present invention.

### DETAILED DESCRIPTION OF THE PREFERRED EMBODIMENTS

Reference will now be made in detail to exemplary embodiments of the present invention, examples of which are illustrated in the accompanying drawings, wherein like reference numerals refer to like elements throughout. The exemplary embodiments are described below to explain the present invention by referring to the figures.

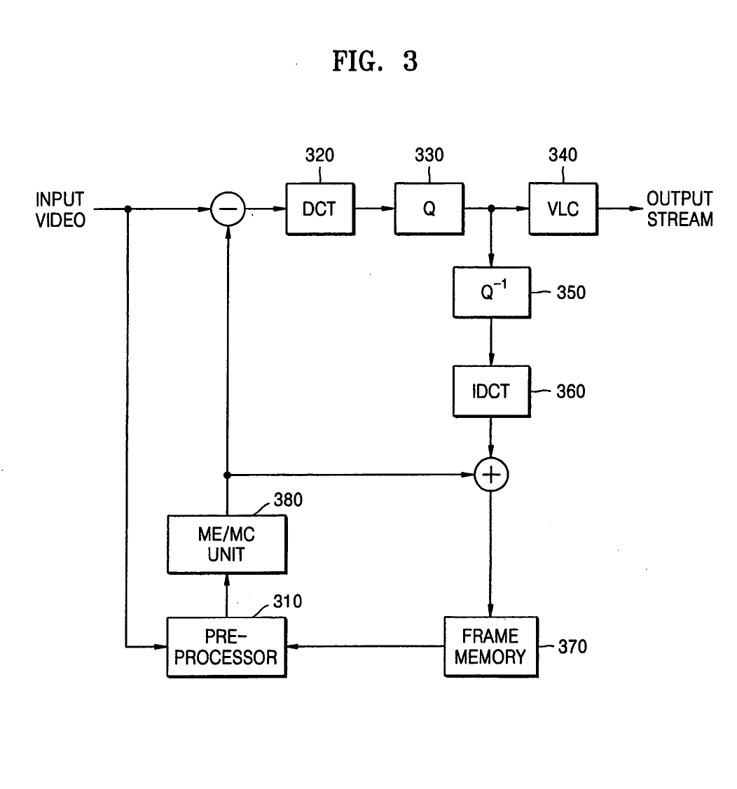

FIG. 3 is a block diagram illustrating a video encoding system, in which the present invention can be applied.

The video encoding system of FIG. 3 may include an MPEG 2 encoder, an MPEG 4 encoder, etc.

Input video data is composed of group-of-picture (GOP) units. A DCT unit 320 performs discrete cosine transform (DCT) on video data into 8×8 block units to obtain spatial redundancy of video data. A quantizaton unit Q 330 quantizes the DCT transformed video data from the DCT unit 320. A de-quantization unit Q⁻¹ 350 de-quantizes the quantized video data from the quantization unit 330. An IDCT unit 360 performs inverse DCT (IDCT) on the de-quantized video data from the de-quantization unit 350. A frame memory 370 stores the de-quantized video data in units of frames. A motion estimation/motion compensation (ME/MC) unit 380 estimates a motion vector MV and SAD for each macro block, using input video data of a current input frame and video data of a previous frame stored in the frame memory 370. A variable length coding (VLC) unit 340 eliminates statistical redundancy in the quantized video data, according to the motion vector estimated by the ME/MC unit 380.

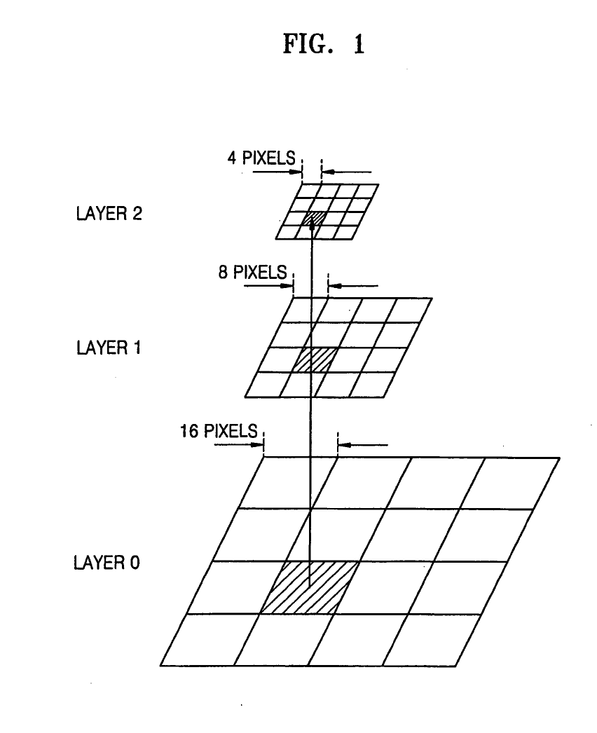

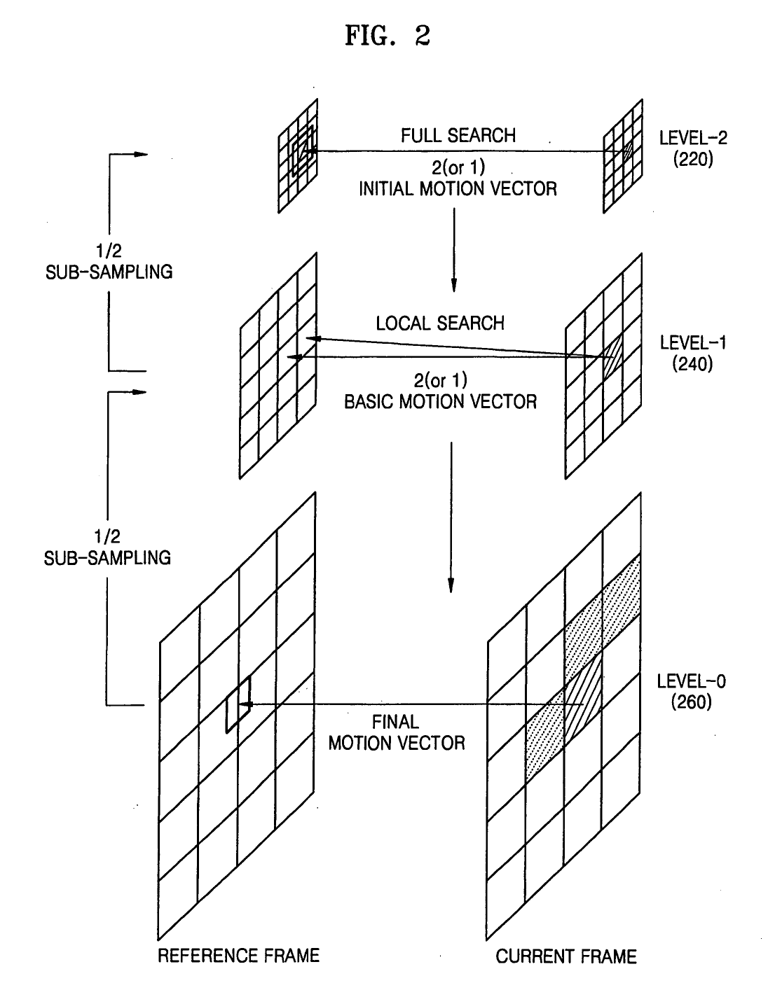

Referring to FIGS. 1 and 2, to accomplish a hierarchical motion estimation method, it is necessary to make both current and reference frames have a multi-resolution structure, through low resolution filtering and sub sampling. To do this, a pre-processor 310 of FIG. 3 generates a low resolution frame by performing sub sampling on the current frame and the reference frame.

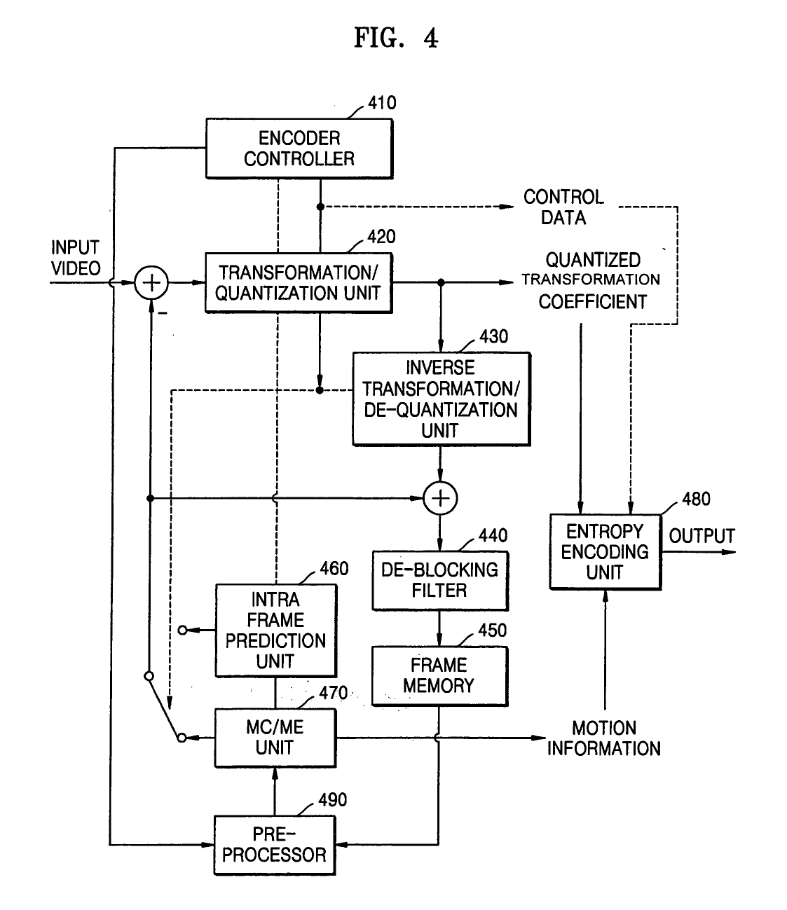

FIG. 4 is a block diagram illustrating a video encoding system, in which the present invention can be applied.

The video encoding system of FIG. 4 may include, for example, a multi-frame based H.264 encoder.

Referring to FIG. 4, the video encoding system includes an encoder controller 410, a transformation/quantization unit 420, an inverse transformation/de-quantization unit 430, a de-blocking filter 440, a frame memory 450, an intra-frame prediction unit 460, motion estimation/motion compensation unit 470, an entropy coding unit 480, and a pre-processor 490.

Of the video encoding system of FIG. 4, the transformation/quantization unit 420, the inverse transformation/de-quantization unit 430, the frame memory 450, the motion estimation/motion compensation unit 470, and the pre-processor 490 perform identical functions to corresponding parts of the system of FIG. 3. Therefore, detailed explanations of these elements will be omitted.

The encoder controller 410 functions as a bit rate controller that determines quantization coefficients for each block to satisfy a desired bit rate throughout an entire sequence and a target bit for each picture.

The de-blocking filter 440 filters the motion compensated video data to remove blocking phenomenon due to the quantization, and stores the result in the frame memory 450.

The intra frame prediction unit 460 obtains a predictor for each block or each macro block in a spatial area in the case of an intra macro block, subtracts the predictor from the intra macro block, and forwards the difference resulting from the subtraction to the transformation unit 420.

The entropy coding unit 480 performs an entropy coding on the quantized data and the motion information under a control of the encoder controller 410.

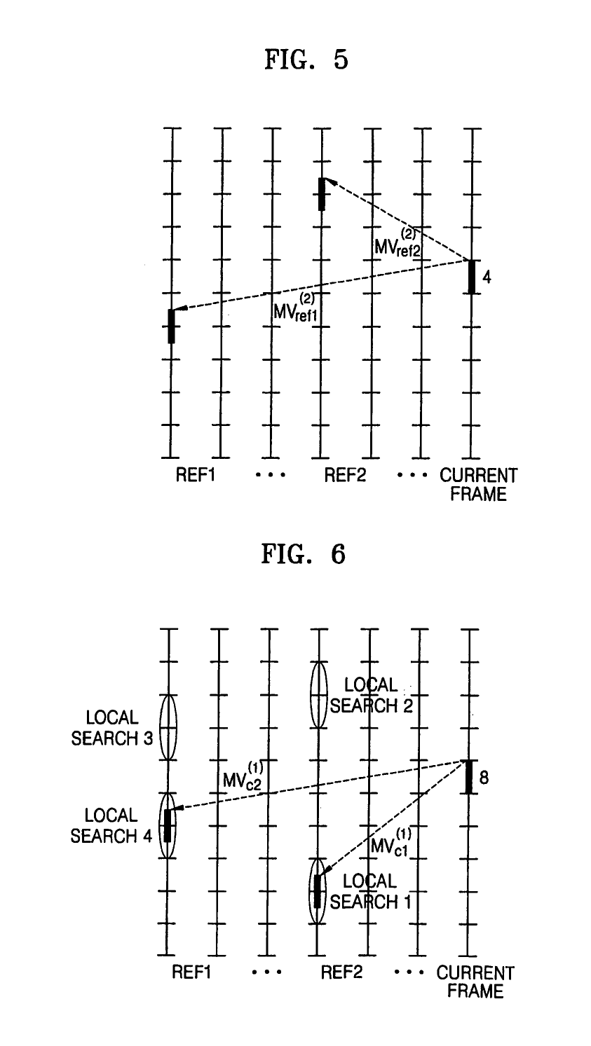

FIG. 5 is a diagram illustrating a motion vector search method performed at low resolution, according to an exemplary embodiment of the present invention. Here, REF1 and REF2 indicate reference frames found to have minimum SAD in motion estimation of a current macro block. MV⁽²⁾_{ref1} denotes the minimum SAD of REF1, where (2) denotes a level 2, i.e., a low resolution level. Similarly, MV⁽²⁾_{ref2} denotes the minimum SAD of REF2.

As an example, two reference frames have been used in an exemplary embodiment of the present invention. However, alternatively, more than two reference frames are also applicable in exemplary embodiments of the present invention. In addition, an embodiment has been illustrated with three resolution levels: a high resolution level L0 as an original resolution level, a middle resolution level L1, and a low resolution level L2. Alternatively, two resolution levels, or more than three resolution levels, are also equally applicable in exemplary embodiments of the present invention.

FIG. 6 is a diagram illustrating a motion vector search method performed at middle resolution, according to an exemplary embodiment of the present invention. Here, REF1 and REF2 indicate reference frames found to have minimum SAD in motion estimation for a current macro block.

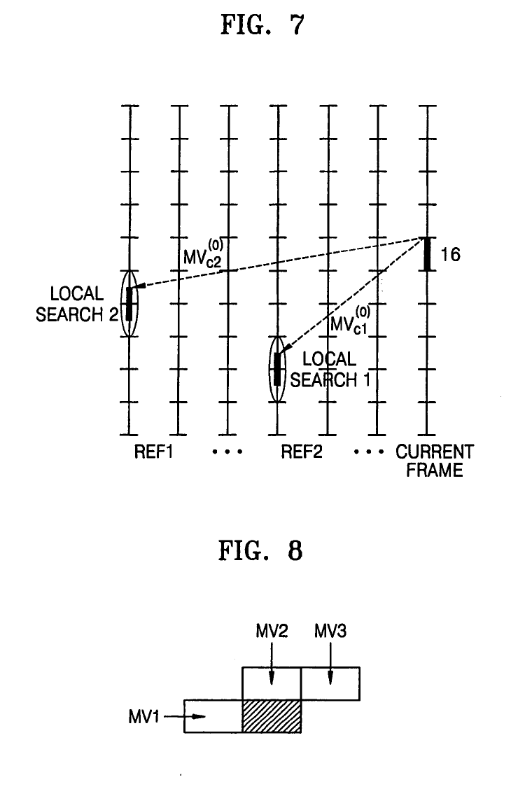

FIG. 7 is a diagram illustrating a motion vector search method performed at a high resolution, according to an exemplary embodiment of the present invention. Here, REF1 and REF2 indicate reference frames found to have minimum SAD in motion estimation for a current macro block.

A method of multi-resolution based motion estimation according to an exemplary embodiment of the present invention will now be described in detail with reference to FIGS. 3 and 4, and FIGS. 5 to 7.

The pre-processor of FIGS. 3 and 4 performs low-pass filtering and sub filtering on current and reference frames to have the frames be in the hierarchical structure as shown in FIG. 1.

Next, the motion estimation (ME) unit 380 and 470 searches for a motion vector with the minimum SAD by performing a full search for motion estimation in units of frames within search areas given for REF1 and REF2, the reference frames of a current macro block at the lowest resolution level, i.e., Level 2. A motion vector with the minimum SAD for the REF1 is referred to as MV⁽²⁾_{ref1}, and a motion vector with the minimum SAD for the REF2 is referred to as MV⁽²⁾_{ref2}.

It is also possible that in the present invention such a full search is performed for more than two reference frames to obtain more than two motion vectors.

Next, for the middle resolution level, Level 1, search areas for REF1 and REF2 over which motion vectors are to be estimated are determined by using the initial motion vectors determined at the low resolution level, Level 2, i.e., MV⁽²⁾_{ref1} and MV⁽²⁾_{ref2}.

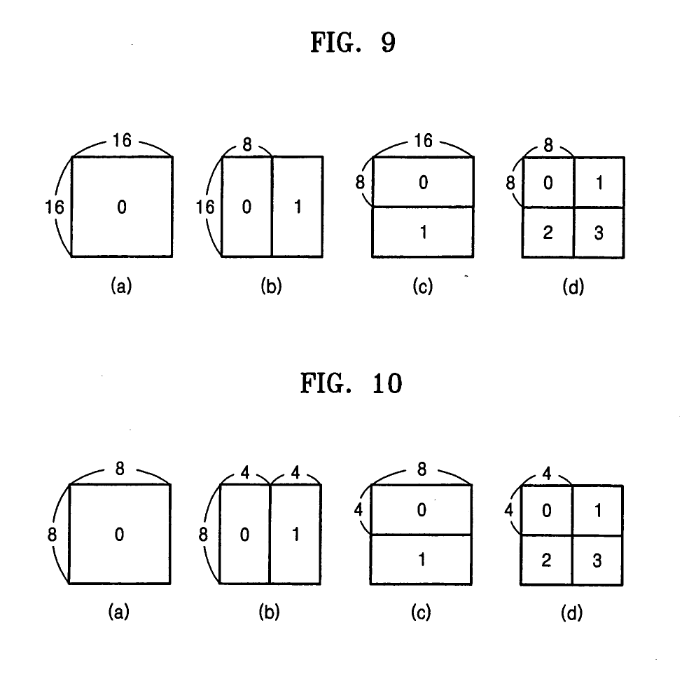

Here, during the local search, motion estimation is performed for each of four modes, each mode being obtained by dividing a macro block into a predetermined number of sub macro blocks. As shown in FIG. 9, a 16×16 sized macro block has not only one motion vector for all the pixels in the macro block, but a number of motion vectors corresponding to various division modes of the macro block. For example, in the case of (b) in FIG. 9, the macro block is divided into two sub macro blocks ‘0’, and ‘1’, and has two independent motion vectors MV1 and MV2 for the two sub macro blocks.

In an exemplary embodiment of the present invention, motion estimation is performed for each of four modes as shown in FIG. 9: (a) a 16×16 mode having a 16×16 sized sub macro block, (b) a 16×8 mode having two 16×8 sized sub macro blocks, (c) a 8×16 mode having two 8×16 sized sub macro blocks, and (d) a 8×8 mode having four 8×8 sized sub macro blocks. For example, for the 8×8 mode, motion estimation is performed for each of the four sub macro blocks, to thereby obtain a motion vector for each sub macro block.

In consideration of costs in obtaining a motion vector for each mode, such as, the amount of SAD, the amount of motion vector bits, and other values, in proportion to the amount of bits of mode information regarding a corresponding mode, two modes having the minimum costs are selected. As a result, various pairs of motion vectors are obtained, for example, for 16×16 and 16×8 modes, or 16×8 and 8×8 modes. Here, motion vectors obtained at the middle resolution level, Level 1, are referred to as basic motion vectors.

A pair of basic motion vectors MV⁽¹⁾_{c1} and MV⁽¹⁾_{c2} are shown in FIG. 6. Here, each basic motion vector is assumed to have one, two, or four motion vectors for 1 6×16, 1 6×8 and 8×16, or 8×8 mode.

Next, motion estimation at the high resolution level, Level 0, is performed using the basic motion vectors MV⁽¹⁾_{c1} and MV⁽¹⁾_{c2} obtained at Level 1.

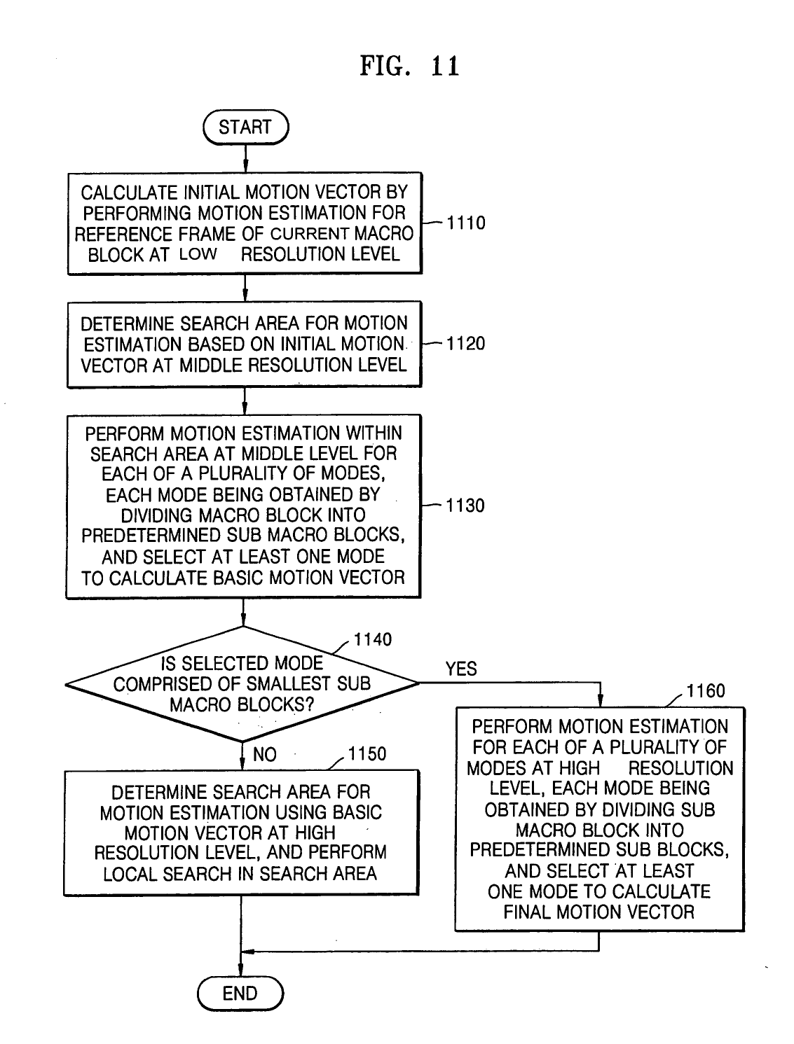

Specifically, search areas for motion estimation at Level 0 are determined using the basic motion vectors at Level 1, and then a local search is performed in the search areas. Here, when the local search is performed for 16×16, 16×8, or 8×16 mode, motion estimation is performed in the corresponding search area. However, when the local search is performed for 8×8 mode, a sub macro block in the 8×8 mode is divided into a predetermined number of sub blocks as shown in FIG. 10. Then, motion estimation is performed for every mode, such as, 8×8, 8×4, 4×8, or 4×4 mode classified in the same way at the middle resolution level. Also, in consideration of costs in obtaining motion estimation for all the modes, a mode having the lowest cost is selected. The reason why the motion estimation for the 8×8 mode is performed in divided sub blocks is that searching in a smaller sub block unit enables costs to be reduced.

Similarly, two final modes are selected and corresponding motion vectors are calculated.

Next, a motion vector having the lowest costs and its corresponding mode are selected through motion vector search with sub-pel precision for the two final modes. And then motion prediction and compensation is performed based on the selected motion vector.

It has been described in the above exemplary embodiment that one local search at the middle resolution level is performed for each reference frame, using the initial motion vectors obtained at the lower resolution level.

However, in other exemplary embodiments of the present invention, it is also possible to consider that at least two local searches are performed for each reference macro block, using other initial motion vectors of neighboring macro blocks of a current macro block at the lower resolution level.

For example, as shown in FIG. 8, a motion vector MV^{spat}_{ref} obtained by calculating a median value of motion vectors of three neighboring macro blocks may be used as another initial vector, which will be referred to as an additional motion vector. Here, the additional motion vector can be obtained by taking median values from X and Y coordinates of motion vectors of the neighboring blocks. For example, if coordinates of the motion vectors of the neighboring blocks are MV1=(5, 6), MV2=(3, 8), and MV3=(7, 7), respectively, the additional motion vector is obtained like this: {median(5, 3, 7), median(6, 8, 7)}=(5, 7).

If the additional motion vector is obtained from neighboring motion vectors at the lower resolution level, the additional motion vector should be subjected to up-sampling to be used. Meanwhile, if the additional motion vector is obtained from neighboring motion vectors at the high resolution level, the additional motion vector should be subjected to down-sampling to be used. However, if the additional motion vector is obtained from neighboring motion vectors at the middle resolution level, the additional motion vector can be used as is. Alternatively, motion vectors being used in current motion vector search algorithms of H.264, MPEG-4, and VC9, etc., may also be used as additional motion vectors.

Motion estimation at the middle resolution level is performed not only in the search area determined by the initial motion vectors obtained at the lower resolution level, but also in the search area determined by the additional motion vectors in the same way.

If motion vectors obtained at a resolution level are to be used for a different resolution level, an appropriate scaling for the motion vectors is needed. For example, a motion vector between neighboring video frames needs to be subjected to double scaling to be used at high resolution.

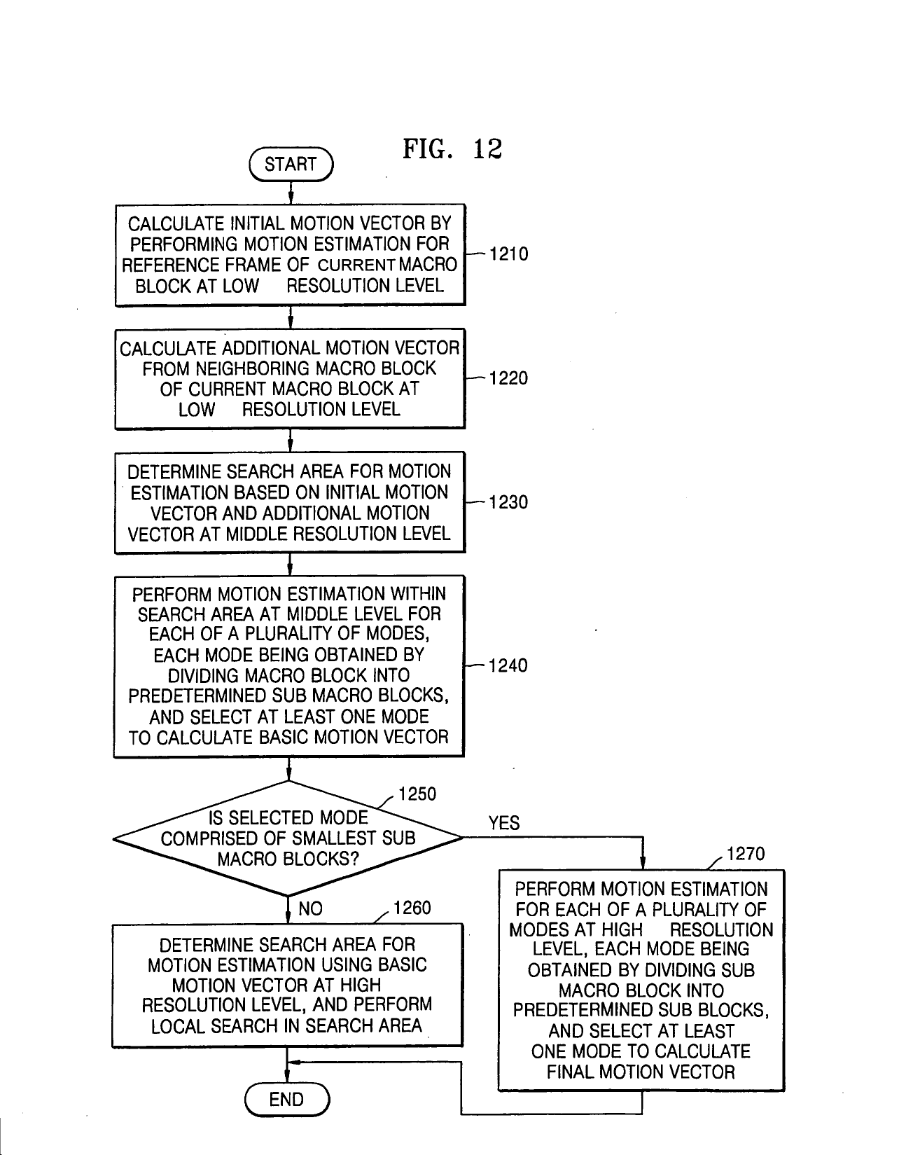

FIG. 11 is a flowchart illustrating an exemplary embodiment of a method of multi-resolution based motion vector estimation, according to an exemplary embodiment of the present invention.

In operation 1110, a full search is performed for motion estimation of a frame unit within a given search area of each of arbitrarily selected reference frames, REF1 and REF2 for a current macro block at the lowest resolution level, Level 2, to obtain motion vectors MV⁽²⁾_{ref1} and MV⁽²⁾_{ref2} of REF1 and REF2 having the minimum SAD.

In operation 1120, search areas for motion estimation for REF1 and REF2 at the middle resolution level, Level 1, are determined by using the motion vectors MV⁽²⁾_{ref1} and MV⁽²⁾_{ref2} obtained at Level 2 as initial motion vectors.

In operation 1130, motion estimation is performed in the search areas at the middle resolution for each of four modes, each mode being obtained by dividing a macro block into a predetermined number of sub macro blocks, as shown in FIG. 9, and two modes are selected by considering costs in motion estimation for the four modes. In other words, motion estimation is performed for each mode: a 16×16 mode having a 16×16 sized sub macro block, a 16×8 mode having two 16×8 sized sub macro blocks, a 8×16 mode having two 8×16 sized sub macro blocks, and a 8×8 mode having four 8×8 sized sub macro blocks, all of which are shown in (a), (b), (c), and (d) of FIG. 9, respectively.

To reduce computational complexities in the motion estimation, SAD is independently calculated in the same search area for 16×16, 16×8, 8×16, and 8×8 modes so that motion estimation is performed for every mode with a single local search.

In operation 1140, it is determined whether one of the two modes selected in operation 1130 is a mode having the smallest sub macro blocks, i.e., the 8×8 mode having 8×8 sized sub macro blocks. If so, procedure goes to operation 1160; otherwise, it goes to operation 1150.

In operation 1150, a search area for motion estimation at the high resolution level, Level 0, is determined by using the basic motion vectors obtained at the middle resolution level, Level 1, and a local search is performed in the search area.

In operation 1160, a corresponding sub macro block is divided into a predetermined number of sub blocks as shown in FIG. 10, and motion estimation is performed for each of modes resulting from the block division, i.e., 8×8, 8×4, 4×8, and 4×4 modes, to thereby select a mode having the lowest cost in the motion estimation. Also, here, in order to reduce computational complexities in the motion estimation, SAD is independently calculated in the same search area for each 8×8, 8×4, 4×8, or 4×4 mode so that motion estimation is performed for every mode with a single local search.

Through motion vector search with sub-pel precision for the finally determined two modes, a motion vector having the lowest cost is selected with its corresponding mode. Motion prediction and compensation is performed based on the selected motion vector.

As such, in the method of multi-resolution based motion estimation according to the present invention, motion estimation is performed for each mode of sub macro blocks at the middle resolution level. Results of the motion estimation at the middle resolution level are used for motion estimation at the high resolution level. In estimation at the high resolution level, if the smallest sub macro block was found to have the lowest costs in motion estimation at the middle resolution level, the sub macro block is divided into sub blocks in each of which motion estimation is performed, thereby narrowing memory bandwidth and reducing a processing cycle for motion estimation, without lowering performance.

FIG. 12 is a flowchart illustrating another exemplary embodiment of a method of multi-resolution based motion estimation, according to an exemplary embodiment of the present invention.

In operation 1210, a full search is performed for motion estimation of a frame unit within a given search area of each of arbitrarily selected reference frames, REF1 and REF2 for a current macro block at the lowest resolution level, Level 2, to obtain motion vectors MV⁽²⁾_{ref1} and MV⁽²⁾_{ref2} of REF1 and REF2 having the minimum SAD.

In operation 1220, other initial motion vectors, i.e., additional motion vectors are calculated from neighboring macro blocks of a current macro block at the lower resolution level. For example, a motion vector MV^{spat}_{ref}, obtained by taking a median value from motion vectors of three neighboring macro blocks as shown in FIG. 8 can be used as the additional motion vector.

In operation 1230, search areas for motion estimation for REF1 and REF2 at the middle resolution level, Level 1, are determined by using the initial motion vectors M⁽²⁾_{ref1}, MV⁽²⁾_{ref2}, and the additional motion vector MV^{spat}_{ref}.

In operation 1240, motion estimation is performed in the search area at the middle resolution level for each of four modes, each mode being obtained by dividing a macro block into a predetermined number of sub macro blocks, as shown in FIG. 9, and two modes are selected by considering costs in motion estimation for the four modes. In other words, motion estimation is performed for each of the four modes: a 16×16 mode having a 16×16 sized sub macro block, a 16×8 mode having two 16×8 sized sub macro blocks, a 8×16 mode having two 8×16 sized sub macro blocks, and a 8×8 mode having four 8×8 sized sub macro blocks, all of which are shown in (a), (b), (c), and (d) of FIG. 9, respectively.

Also, here, to reduce computational complexities in the motion estimation, SAD is independently calculated in the same search area for 16×16, 16×8, 8×16, and 8×8 modes so that motion estimation is performed for every mode with a single local search.

In operation 1250, it is determined whether one of the two modes selected in operation 1240 is a mode having the smallest sub macro blocks, i.e., the 8×8 mode having 8×8 sized sub macro blocks. If so, the procedure goes to operation 1270; otherwise, it goes to operation 1260.

In operation 1260, a search area for motion estimation at the high resolution level, Level 0, is determined by using the basic motion vectors obtained at the middle resolution level, Level 1, and a local search is performed in the search area.

In operation 1270, a corresponding sub macro block is divided into a predetermined number of sub blocks as shown in FIG. 10, and motion estimation is performed for each of modes resulting from the block division, i.e., 8×8, 8×4, 4×8, and 4×4 modes, to thereby select 2 modes having the lowest cost in the motion estimation. Also, here, in order to reduce computational complexities in the motion estimation, an SAD is independently calculated in the same search area for each 8×8, 8×4, 4×8, or 4×4 mode so that motion estimation is performed for every mode with a single local search. Through motion vector search with sub-pel precision for the finally determined two modes, a motion vector having the lowest cost is selected with its corresponding mode. Motion prediction and compensation is performed based on the selected motion vector.

It is possible for the method of multi-resolution based motion estimation described above according to the present invention to be implemented as a computer program. Codes and code segments constituting the computer program may be provided by those skilled in the art. The computer programs may be recorded on computer-readable media and read and executed by computers, computing devices, processors, programmable apparatuses, and the like. Such computer-readable media include all kinds of storage devices, such as ROM, RAM, CD-ROM, magnetic tape, floppy disc, optical data storage devices, etc. The computer readable media also include everything that is realized in the form of carrier waves, e.g., transmission over the Internet. The computer-readable media may be distributed to computers, computing devices, processors, programmable apparatuses, computer systems, and the like connected to a network, and codes on the distributed computer-readable media may be stored and executed in a decentralized fashion.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. A method of multi-resolution based motion estimation, the method comprising:
calculating an initial motion vector in a predetermined block of a current frame at a low resolution;
determining a search area at a middle resolution based on the initial motion vector;
performing motion estimation in the search area for each of a plurality of modes, each mode being obtained by dividing a macro block into a predetermined sub macro blocks; and
selecting at least one mode among the plurality of modes which have each been subjected to the motion estimation at the middle resolution, and performing motion estimation for a high resolution based on motion vectors for the selected modes,
wherein the plurality of modes have different sized sub macro blocks.

2. The method of claim 1, wherein the selecting of at least one mode is performed on the basis of results from motion estimation for each mode.

3. The method of claim 1, wherein if one of the selected modes is composed of minimally sized sub macro blocks, performing motion estimation for the high resolution comprises performing motion estimation for each of a plurality of modes, each mode being obtained by dividing a minimum-size sub macro block into a predetermined number of sub blocks.

4. The method of claim 1, wherein the plurality of modes are obtained by dividing the macro block into a 16×16 sized sub macro block, two 16×8 sized sub macro blocks, two 8×16 sized sub macro blocks, and four 8×8 sized sub macro blocks, and for each mode, motion estimation is performed in every sub macro block, and thereby the number of motion vectors for each mode is equal to the number of sub macro blocks in the corresponding mode.

5. The method of claim 1, wherein selecting at least one mode is performed by selecting one or more modes having the lowest costs in motion estimation, the costs including one or more factors from among sum of absolute differences (SAD), bits of a motion vector, and bits of mode information.

6. The method of claim 1, wherein the initial motion vector is calculated with reference to at least one frame neighboring the current frame.

7. The method of claim 1, further comprising:
calculating an additional motion vector using motion vectors of neighboring blocks of a predetermined block,
wherein determining the search area for the middle resolution includes determining a search area based on the additional motion vector.

8. The method of claim 7, wherein the additional motion vector has a median value of the motion vectors of the neighboring blocks.

9. The method of claim 4, wherein if one of the selected modes is a mode for motion estimation in an 8×8 sized sub macro block, the motion estimation for the high resolution comprises performing motion estimation for each of a plurality of modes, each mode being obtained by dividing the 8×8 sized sub macro block into a predetermined number of sub blocks.

10. The method of claim 1, wherein the motion estimation method is applicable to an H.264 encoder.

11. The method of claim 1, wherein performing motion estimation for each mode at the middle resolution level is done by independently calculating SAD for every sub macro block of the corresponding mode in the search area.

12. The method of claim 1, wherein performing motion estimation for each mode at the high resolution layer is done by independently calculating SAD for every sub block of the corresponding mode in the search area.

13. A recording medium storing a program to implement a method of multi-resolution based motion estimation, the method comprising:
calculating an initial motion vector in a predetermined block of a current frame at a low resolution;
determining a search area at a middle resolution based on the initial motion vector;
performing motion estimation in the search area for each of a plurality of modes, each mode being obtained by dividing a macro block into a predetermined number of sub macro blocks; and
selecting at least one mode among the plurality of modes which have each been subjected to the motion estimation at the middle level, and performing motion estimation for a high resolution based on motion vectors for the selected modes,
wherein the plurality of modes have different sized sub macro blocks.

14. A method of multi-resolution based motion estimation, comprising:
performing a motion estimation for a reference frame of a current macro block at a low resolution to provide an initial motion vector;
determining a search area at a middle resolution based on the initial motion vector;
performing motion estimation in the search area for each of a plurality of modes, each mode being obtained by dividing a macro block into sub macro blocks, wherein one of the sub macro blocks is the macro block;
selecting at least one mode among the plurality of modes subjected to the motion estimation at the middle resolution; and
performing motion estimation for a high resolution based on motion vectors for the selected modes.

15. The method of claim 14, wherein the plurality of modes have different sized sub macro blocks.

16. The method of claim 14, further comprising calculating an additional motion vector using motion vectors of neighboring blocks of the macro block at the low resolution, wherein determining the search area at the middle resolution further includes determining a search area based on the initial motion vector and the additional motion vector.

17. At least one computer readable medium storing instructions that control at least one processor which executes a method of multi-resolution based motion estimation to perform the method comprising:
performing a motion estimation for a reference frame of a current macro block at a low resolution to provide an initial motion vector;
determining a search area at a middle resolution based on the initial motion vector;
performing motion estimation in the search area for each of a plurality of modes, each mode being obtained by dividing a macro block into sub macro blocks, wherein one of the sub macro blocks is the macro block;
selecting at least one mode among the plurality of modes subjected to the motion estimation at the middle resolution; and
performing motion estimation for a high resolution based on motion vectors for the selected modes.

18. The medium of claim 16, wherein the plurality of modes have different sized sub macro blocks.

19. The medium of claim 16, further comprising calculating an additional motion vector using motion vectors of neighboring blocks of the macro block at the low resolution, wherein determining the search area at the middle resolution further includes determining a search area based on the initial motion vector and the additional motion vector.
